(19) United States
(12) Patent Application Publication
(10) Pub. No.: US 2005/0122106 A1
(43) Pub. Date: Jun. 9, 2005

(54) Gradient coil arrangement

(76) Inventors: Cornelis Leonardus Gerardus Ham, Eindhoven (NL); Johannes Adrianus Overweg, Uelzen (DE); Gerardus Nerius Peeren, Eindhoven (NL)

Correspondence Address: Thomas M Lundin;Philips Intellectual Property & Standards, 595 Miner Road, Cleveland, OH, 44143, US

(21) Appl. No.: 10/499,175

(22) PCT Filed: Dec. 16, 2002
(86) PCT No.: PCT/IB02/05386

(30) Foreign Application Priority Data
Dec. 17, 2001 (EP) 01204934.2

(51) Int. Cl. G01V 3/00

(52) U.S. Cl. 324/318

(57) ABSTRACT

The invention relates to a gradient coil arrangement for the generation of a gradient magnetic field for an MR arrangement with at least two gradient coils arranged on a cylinder surface with a substantially circular cross section. In order to enable adjustment of gradient fields extending as linearly as possible in the area of an object to be examined without having to modify the entire mechanical structure of the MR arrangement and without having to increase the power required to feed the gradient coil arrangement, it is proposed according to the invention to configure the gradient coils so as to be asymmetrical in relation to a central plane lying horizontally through the longitudinal axis of the cylinder.

The invention relates to a gradient coil arrangement for the generation of a gradient magnetic field for an MR arrangement with at least two gradient coils arranged on a cylinder surface with a substantially circular cross section. The invention also relates to a coil arrangement for an MR arrangement and to an MR arrangement itself.

Gradient coil arrangements of this type are used in all magnetic resonance arrangements (MR arrangements) to superimpose a gradient magnetic field on a static magnetic field in the x-, y- and z-directions. The gradient coils are then arranged in several layers within the main field magnets on the surface of a cylinder with a circular cross section, within which the patient is arranged for examination.

To scan the patient more quickly and obtain the required image data more quickly, the gradient coils must be switched more quickly for which the necessary gradient magnetic fields have to be generated more quickly by the gradient coils. However, at the same time the power of the gradient amplifier assigned to the gradient coils must not be increased any further, the consequence of which would be a significant cost increase. In order to improve the efficiency of the gradient coils, therefore, preferably their design should be improved.

Known from EP 1 099 952 A2 is a gradient coil arrangement for an MR device in which the power required to feed the gradient coil arrangement is reduced in that the conductors in a high-frequency coil arrangement located below a patient table have a shorter distance from the symmetrical axis of the cylinder than the conductors located above the patient table and that the cross section of the gradient coil arrangement is matched to the cross section of the high-frequency coil arrangement. The gradient coil arrangement is, therefore, designed asymmetrically in relation to a central plane lying horizontally through the cylinder's longitudinal axis. However, this solution has the drawback that an asymmetrical gradient coil arrangement of this type, i.e. no longer having a circular cross section, is heavier, and hence more expensive to produce, than a gradient coil arrangement with a circular cross section. In addition, with this solution there is much less space within the cylinder for the insertion of the patient table, the actual patient and other electronic equipment. Moreover, combination with vacuum insulation is very difficult to achieve in this case.

It is, therefore, the object of the invention to provide a gradient coil arrangement with which the power required to feed the gradient coil arrangement is reduced, but which does not require the extensive mechanical modifications necessary for the known gradient coil arrangement. According to the invention, this object is achieved by means of a gradient coil arrangement as claimed in claim 1 in which the gradient coils are designed asymmetrically in relation to a central plane lying horizontally through the cylinder's longitudinal axis.

Therefore, unlike the solution known from EP 1 099 952 A2, the gradient coils in the solution according to the invention retain a circular cross section so that the gradient coil arrangement overall has a cylindrical shape and overall no mechanical modifications with regard to the arrangement of the gradient coil arrangement need to be performed on the MR arrangement. Only the actual gradient coils, and this in particular concerns the arrangement and number of the windings in the gradient coils, have an asymmetrical shape in relation to said central plane, i.e. the arrangement and number of windings in the gradient coils or parts of the gradient coils arranged above the central plane differs from the shape and arrangement of the windings in the gradient coils, or parts of the gradient coils, arranged below the central plane.

With the gradient coil arrangement according to the invention, therefore, an asymmetrical gradient magnetic field is generated within the cylinder, where the gradient magnetic field generated below the central plane should have the smallest possible field strength and may also have nonlinearities. The center of the linear field area does not coincide with the center of the cylinder. The gradient coil arrangement also has adequate dimensions to enable the patient to be arranged completely within the cylinder. While the gradient coils, therefore, do not have top-bottom symmetry, symmetry exists in both horizontal directions, i.e. in the back-front direction and the left-right direction. The stored energy in the gradient coils is in this way reduced overall so that amplifiers of lower power may be used without the system power in the imaging area being reduced.

Advantageous embodiments of the gradient coil arrangement according to the invention may be found in the dependent claims. The invention also relates to a coil arrangement for an MR arrangement with an x-gradient coil arrangement, a y-gradient coil arrangement and a z-gradient coil arrangement, the gradient coil arrangements being embodied as described in claim 1 or in the associated dependent claims. In addition, the invention also relates to an MR arrangement with a coil arrangement of this type.

In order to generate a gradient field which is as linear as possible above the central plane with the smallest possible amount of energy, it is provided in an advantageous embodiment of the gradient coil arrangement that the number of turns in the gradient coils above the central plane is greater than the number of turns below the central plane. The stored energy should be as low as possible to enable the amplifier to establish the gradient field with the lowest amount of power possible.

Alternatively or additionally, it may be provided that the distances between adjacent turns in the gradient coils below the central plane may be less than the distances between adjacent turns above the central plane. This also enables the linearity of the gradient field and the size of the area in which a linear gradient field is generated above the central plane to be increased.

The dependent claims 5 to 8 contain preferred embodiments of the gradient coil arrangement according to the invention such as preferably used for x-, y- and z-gradient coils. Common to all the embodiments is the fact that the individual gradient coils are asymmetrical in relation to the central plane and that they are embodied in such a way that, in particular in the area to be examined above the central plane, a sufficiently linear gradient magnetic field is generated, by the coil's stored energy being as low as possible.

In the majority of coil arrangements for MR arrangements, the y-gradient coil arrangements are embodied in that two y-gradient coils are arranged above and two y-gradient coils are arranged completely below the central plane and that the x-gradient coils are rotated 90° about the cylinder's longitudinal axis so that each of the four x-gradient coils is arranged half above and half below the central plane. With an embodiment of this kind, consequently, x- and y-gradient coils according to the invention are embodied differently since in each case they are asymmetrical in relation to the central plane.

The x- and y-gradient coil arrangements may, however, also be rotated 45° about the cylinder's longitudinal axis compared to the most commonly used and already described arrangement so that the x- and y-gradient coils are constructed identically. An embodiment of this kind is described in claim 9. Once again with this embodiment, however, the x- and y-gradient coil arrangements are rotated 90° to each other about the cylinder's longitudinal axis.

The invention will be further described with reference to examples of embodiments shown in the drawings to which, however, the invention is not restricted.

Here:

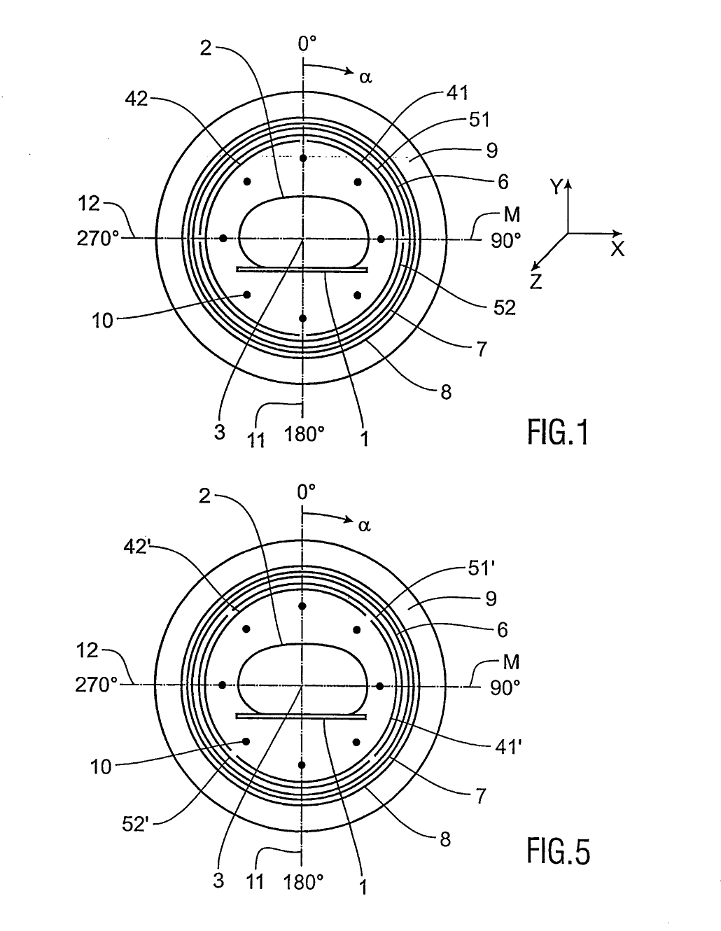

FIG. 1 shows a cross section through a first embodiment of an MR arrangement according to the invention,

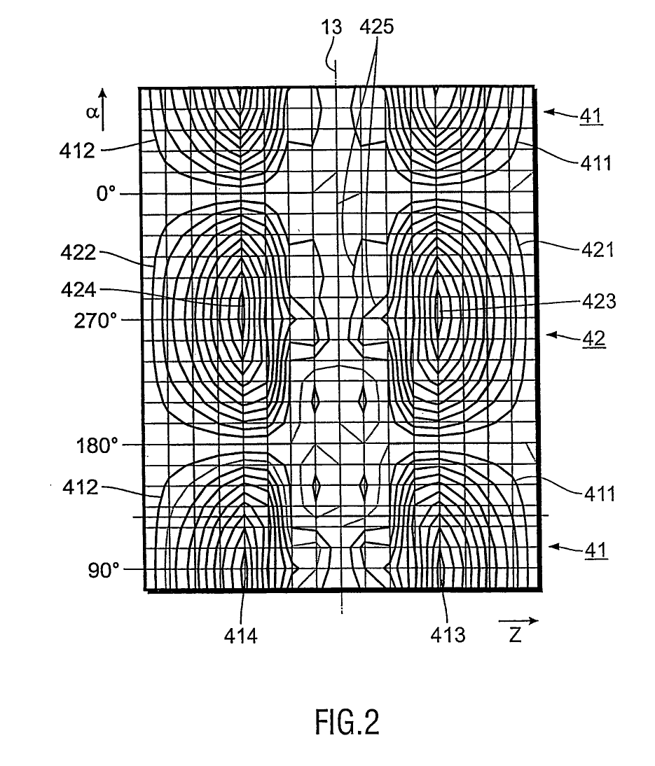

FIG. 2 shows the course of the turns on a development of an x-gradient coil arrangement according to the invention,

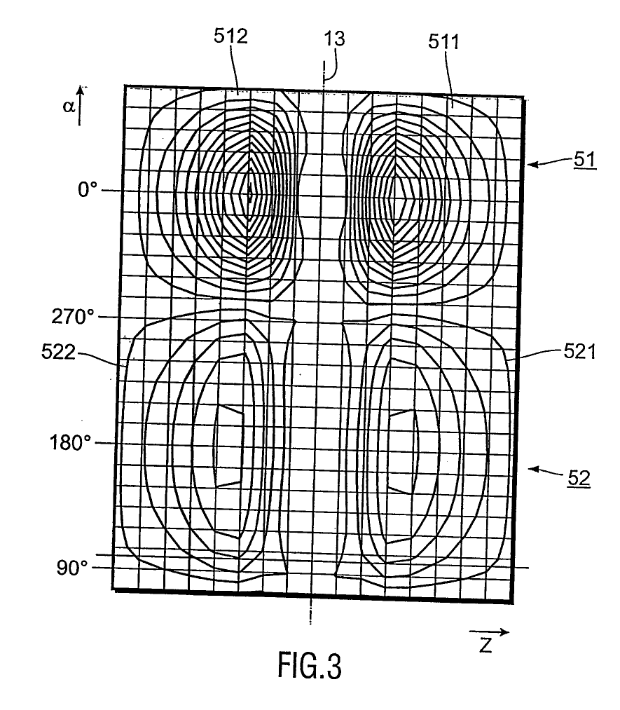

FIG. 3 shows the spatial course of the windings on a development of a y-gradient coil arrangement according to the invention,

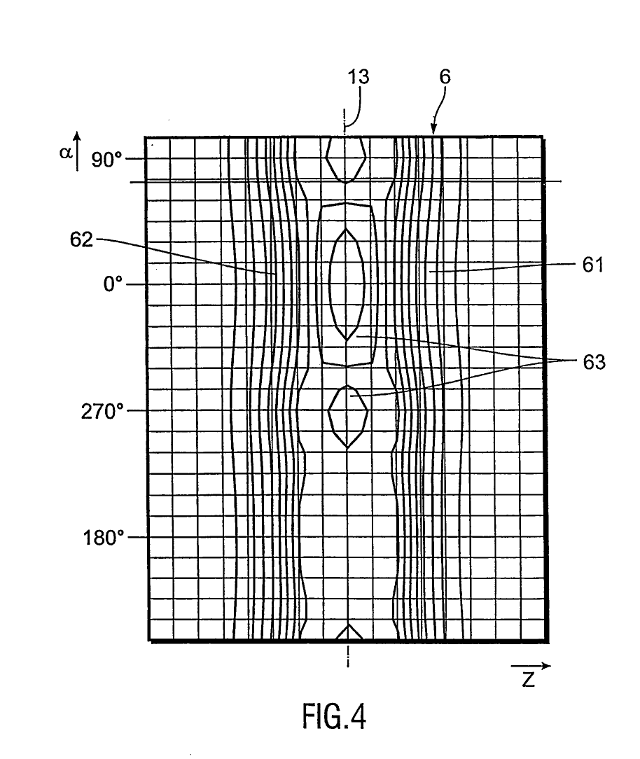

FIG. 4 shows the spatial course of the turns on a development of a z-gradient coil arrangement according to the invention, and

FIG. 5 shows a cross section through an alternative embodiment of an MR arrangement according to the invention.

In the MR arrangement shown in cross section in FIG. 1, the reference 1 denotes the positioning on a table of an object 2 for examination, for example, a patient. The object is arranged in the isocenter 3 of several coil arrangements surrounding the object 2 in a cylindrical shape. To excite the area to be examined and/or to receive MR signals from the area to be examined, the object 2 is first surrounded by a high-frequency coil arrangement 10 which is embodied, for example, as a birdcage and, as in the example shown, has eight conductors running perpendicularly to the plane of projection in FIG. 1. To generate gradient magnetic fields in the three spatial directions x, y and z of a Cartesian coordinate system, different gradient coil arrangements are provided which also surround the object 2 in a ring shape and are each arranged on a cylinder surface.

To generate a gradient magnetic field running in the x-direction, an x-gradient coil arrangement is provided comprising two groups 41, 42 of two gradient coils each, i.e. a total of four saddle coils, each enclosing the object 2 in the form of a circular arc in an angular range of almost 180° about the z axis of symmetry 3 on a cylinder surface. The development of the individual windings in this x-gradient coil arrangement along the angle α about the z-axis of symmetry 3, plotted along the z-axis, is shown in greater detail in FIG. 2. This shows the four saddle coils 411, 412, 421, 422 with the two saddle coils 411, 412 surrounding the object 2 approximately in the angular range of 0° to 180°, while the saddle coils 421, 422 surround the object 2 approximately in the angular range of 180° to 0°. The saddle coils 411 and 412 or 421 and 422 are each embodied symmetrically to the plane of symmetry 13 which runs perpendicularly to the plane of projection in FIG. 2.

It is provided according to the invention that the x-gradient coils are embodied asymmetrically in relation to the central plane M, i.e. the plane in FIG. 1 lying horizontally through the x-axis of symmetry 12 and perpendicularly to the y-axis of symmetry 11. This means that the eye 413, 414, 423, 424 of the saddle coil 411, 412, 421, 422 in question is not arranged exactly in this central plane M, but slightly above this plane, as is easily deducted from FIG. 2. In addition, the turns in the individual saddle coils are asymmetrical in relation to the central plane M in the area adjacent to the plane of symmetry 13. For example, with the saddle coil 421 in the area adjacent to the plane of symmetry 13, the turns 425 in the angular range between 270° and 0° cover a larger area than between 180° and 270°. Preferably, all the turns may be embodied in such a way that the area above the central plane M covered by each individual turn is greater than area below the central plane M covered by the same turn.

FIG. 1 also shows the arrangement of a y-gradient coil arrangement comprising two groups 51, 52 of two gradient coils each on a cylinder surface about the axis of symmetry 3. The development of the windings in the y-gradient coil arrangement is shown again in FIG. 3 in more detail. This arrangement comprises a total of four y-gradient coils 511, 512, 521, 522 in the form of saddle coils, the saddle coils 511, 512 being arranged in the angular range between 270° and 90°, i.e. above the central plane M, and the saddle coils 521, 522 in the angular range of 90° to 270°, i.e. below the central plane M. In each case, two saddle coils are again almost symmetrical in relation to the plane of symmetry 13. It is provided that the saddle coils 511, 512 arranged above the central plane M have significantly more turns than the saddle coils 521, 522 arranged below the central plane M, as may be clearly seen in FIG. 3.

To generate a z-gradient field, in addition, as shown in FIG. 1, a z-gradient coil arrangement 6 is provided which is also arranged on a cylinder surface with a circular cross section around the object 2. A z-gradient coil arrangement of this type is shown, in developed form, in more detail in FIG. 4. This arrangement has two z-gradient coils 61, 62 running symmetrically to the plane of symmetry 13, surrounding the object 2 in a ring shape and one or more closed turn loops 63. It is provided according to the invention that the turns in the z-gradient coils 61, 62 do not run parallel to the plane of symmetry 13, i.e. do not lie in planes running perpendicularly to the z-plane, but have a partially curved or bent course. In addition, the turns in each of the z-gradient coils 61, 62 have constrictions in many angular ranges, i.e. lie close together than in many other angular ranges, in which the distances of individual turns from each other are greater. For example, in the angular range of about 0°, the distances between the individual windings in the z-gradient coils 61, 62 are greater than the distances of the individual windings in the angular range of about 180°.

A further special feature according to the invention is the closed turn loops 63 along the plane of symmetry 13 between the z-gradient coils 61, 62, which are only arranged above the central plane M and preferably lie in the angular range of about 0°.

By the number and construction of the individual gradient coils according to the invention it is achieved notably that in the area above the central plane M, linear gradient magnetic fields may be generated which may be switched more quickly without it being necessary to modify the embodiment of the entire MR arrangement to any significant extent. According to the invention, in addition, the cylinder-symmetrical construction of the gradient coils with a circular cross section is obtained so that there is also sufficient space for the patient table with the patient and additional other electronic equipment in the interior of the gradient coils. The fact that the gradient coils according to the invention produce an asymmetrical gradient field in relation to the central plane is not a drawback, since the patient is usually arranged substantially above the central plane.

For the embodiment of the MR arrangement of in FIG. 1, in addition to elements already mentioned also shown is a plastic tube 7 concentric to the z axis of symmetry 3 which surrounds the gradient coils and on the exterior of which there is provided an active shield 8 for the gradient coils. This shield 8 is used to compensate the magnetic fields generated by the gradient coils in the external area, so that no eddy currents are generated in a metal housing of a cryostat 9. The cryostat 9 contains a supraconductive magnet, not shown in any more detail, which generates a stationary magnetic field perpendicular to the plane of projection. Said elements 7 to 9 are generally known and will not, therefore, be described in any more detail. In the embodiment of the gradient coil according to the invention, the shield coil elements have features comparable to those of the primary coils.

An alternative embodiment of an MR arrangement according to the invention is shown in FIG. 5. This embodiment differs from the embodiment shown in FIG. 1 in the different arrangement of the individual gradient coils 41′, 42′, 51′, 52′ in the x-gradient coil arrangement and the y-gradient coil arrangement. While the embodiment of the individual gradient coils in the x- and y-gradient coil arrangements shown in FIG. 1 are symmetrical in relation to the y axis of symmetry 11 running in the y-direction or the x axis of symmetry 12 running in the x-direction, in the embodiment shown in FIG. 5 these symmetries in the arrangement are displaced 45° in the α-direction. This means that in each case two gradient coils in the x- and y-gradient coil arrangements, i.e. the gradient coils in the groups of two 42′ and 51′, are arranged three quarters above the central plane M and one quarter below the central plane M, while the gradient coils in the other groups of two 41′, 52′ in these gradient coil arrangements are each arranged three quarters below the central plane M and one quarter above the central plane M. Compared to the embodiment shown in FIG. 1, this has the advantage that the gradient coils in x- and y-gradient coil arrangements do not have to be embodied differently, as shown in FIGS. 2 and 3, but in each case four out of a total of eight gradient coils required, i.e. each time two gradient coils in each gradient coil arrangement, may be embodied identically. Therefore, it is only necessary to design a total of two different coils for the x- and y-gradient coil arrangements. Nevertheless, the embodiment of the individual coils still enables a linearly running gradient field substantially above the central plane to be achieved.

1. A gradient coil arrangement for the generation of a gradient magnetic field for an MR arrangement with at least two gradient coils arranged on a cylinder surface (41, 42, 51, 52, 61, 62) with a substantially circular cross section, characterized in that the gradient coils (41, 42, 51, 52, 61, 62) are embodied asymmetrically in relation to a central plane (M) lying horizontally through the cylinder's longitudinal axis (3).

2. A gradient coil arrangement as claimed in claim 1, characterized in that the gradient coils (41, 42, 51, 52, 61, 62) are embodied for the generation of a linear gradient field only above the central plane (M).

3. A gradient coil arrangement as claimed in claim 1, characterized in that the number of turns of the gradient coils (41, 42, 51, 52, 61, 62) above the central plane (M) is greater than the number of turns below the central plane (M).

4. A gradient coil arrangement as claimed in claim 1, characterized in that the distances between adjacent turns of the gradient coils (41, 42, 51, 52, 61, 62) below the central plane (M) are less than the distances between adjacent turns above the central plane (M).

5. A gradient coil arrangement as claimed in claim 1, characterized in that the gradient coil arrangement has two z-gradient coils (61, 62), the turns of which below the central plane (M) are each time positioned more closely together than the turns above the central plane (M), and that between the z-gradient coils (61, 62) above the central plane (M) a closed turn loop (63) is arranged.

6. A gradient coil arrangement as claimed in claim 1, characterized in that the gradient coil arrangement has four y-gradient coils (511, 512, 521, 522) in the form of saddle coils, the two saddle coils (511, 512) arranged above the central plane (M) having more turns than the saddle coils (521, 522) arranged below the central plane (M).

7. A gradient coil arrangement as claimed in claim 1, characterized in that the gradient coil arrangement has four x-gradient coils (411, 412, 421, 422) in the form of saddle coils, each saddle coil being arranged approximately half above and half below the central plane (M) and the covered area of the individual turns of the saddle coils above the central plane (M) being greater than the covered area of the same turn below the central plane (M).

8. A gradient coil arrangement as claimed in claim 7, characterized in that the center of the eye (423) of the saddle coils (421) is arranged slightly above the central plane (M).

9. A gradient coil arrangement as claimed in claim 1, characterized in that the gradient coil arrangement has four x- and/or y-gradient coils (41′, 42′, 51′, 52′) in the form of saddle coils, two saddle coils (42′, 51′) being arranged with approximately three quarters of each saddle coil above and one quarter below the central plane (M) and two saddle coils (41′, 52′) being arranged with one quarter above and three quarters below the central plane (M).

10. A coil arrangement for an MR arrangement with an x-gradient coil arrangement, a y-gradient coil arrangement and a z-gradient coil arrangement, the gradient coil arrangements being embodied as disclosed in one of the above claims.

11. An MR arrangement with a coil arrangement as claimed in claim 10.
